(19) United States
(12) Patent Application Publication
(10) Pub. No.: US 2022/0156945 A1
(43) Pub. Date: May 19, 2022

(54) Method for motion estimation based on motion blur

(71) Applicant: Luuk van Dijk, Zurich (CH)

(72) Inventor: Luuk van Dijk, Zurich (CH)

(21) Appl. No.: 17/099,977

(22) Filed: Nov. 17, 2020

(51) Int. Cl. G06T 7/246; G06T 5/00; G06T 5/20

(52) U.S. Cl. CPC G06T 7/248; G06T 5/002; G06T 2207/20201; G06T 2207/10016; G06T 5/20

(57) ABSTRACT

A method for motion estimation based on perceived blur due to motion between a first image frame and a second image frame of a digital video sequence comprises estimating a motion vector between the frames for each of a plurality of pixel blocks in the first and second image frames. A patch motion vector is then estimated for each of a plurality of patches of the motion vectors based on one of vectors in each patch and motion vectors in proximate patches. The patch motion vector of its corresponding patch is allocated to each pixel in the first frame. A system and computer program for motion estimation based on perceived blur is also provided.

### BACKGROUND OF THE INVENTION

It is well known that moving objects captured on digital imaging and/or video can appear blurry to an observer. The perceived blur is known to be caused in part by the fact that cameras have finite exposure times and if a scene exhibits too much change between images in the time the time the camera shutter is open, the images may exhibit what is called “motion blur.”

Algorithms exist to de-blur the images with the goal to make the image clearer for the human observer and for application in image recognition or image processing. For example, U.S. Patent Application Publication No. 2002/0154088 to Nishimura discloses a method for displaying an image on an LCD display which, based on a determined motion vector, switches between an image signal making up the input image and a blanking signal. The method is purported to reduce the flickering, trailing and image-retention phenomenon caused by prior attempts to compensate for the physical characteristics of an LCD display compared to a CRT device. The method factors the speed of image motion to alter the rate at which the non-image signal is displayed. In particular, when motion of an image is fast, the rate at which the non-image signal is displayed during one frame is increased and control is exerted such that the level of the non-image signal comes nearer to the level of white color rather than the level of black color. The converse is true when the motion of an image is slow. As such, display luminance and contrast is generally increased.

In contrast to present case, instead of using the motion blur as a problem to be solved and a corrected image as the output, the motion blur can itself be analyzed for valuable information on the in-image motion that can be used for advantageous piloting, flying, landing, and/or other general navigational purposes. Accordingly, it is an object to provide a novel method and system for estimating motion and based on a perceived motion blur in digital imaging and/or video.

### SUMMARY OF THE INVENTION

According to one aspect there is provided a method of estimating motion of pixels between a first frame and a second frame in a digital video sequence, comprising:

estimating a motion vector between the frames for each of a plurality of pixel blocks of said first and second frames;

estimating a patch motion vector for each of a plurality of patches of motion vectors based on one of motion vectors in each patch and or motion vectors in proximate patches; and

allocating to each pixel in the first frame, the patch motion vector of its corresponding patch.

The estimating a motion vector may comprise dividing the first and second frames into a plurality of the pixel blocks and wherein said motion vector estimating comprises: for each of the pixel blocks, selecting from a list of motion vector candidates a motion vector that provides the least difference between the pixel block in the first frame and a corresponding pixel block in the second frame.

Estimating the patch motion vector may comprise assigning patch motion vectors to respective ones of the patches that have a first threshold proportion of motion vectors with substantially the same direction and at least a threshold average extent; and in the event that less than a second threshold proportion of assigned patch motion vectors have substantially the same direction, iteratively assigning the motion vectors of assigned patches to proximate ones of unassigned patches.

In accordance with another aspect, there is provided a method of estimating motion for perceived blur due to motion between a first frame and a second frame of a digital video sequence comprising:

estimating a motion vector between the frames for each of a plurality of pixel blocks in the frames;

estimating a patch motion vector for each of a plurality of patches of motion vectors based on one of motion vectors in each patch and motion vectors in proximate patches;

allocating to each pixel in the first frame, the patch motion vector of its corresponding patch;

weighting each pixel; and

combining each patch motion vector and its respective pixel.

In accordance with another aspect, there is provided a system for estimating motion of pixels between a first frame and a second frame in a digital video sequence, comprising:

a block vector calculator determining a motion vector between the frames for each of a plurality of pixel blocks of the first and second frames;

a patch vector calculator determining a patch motion vector for each of a plurality of patches of motion vectors based on one of motion vectors in each patch and motion vectors of proximate patches; and

a pixel vector allocator allocating to each pixel in the first frame, the patch motion vector of its corresponding patch.

In accordance with another aspect, there is provided a computer readable medium including a computer program for estimating motion of pixels between a first frame and a second frame in a digital video sequence, the computer program comprising:

computer program code for estimating a motion vector between the frames for each of a plurality of pixel blocks of said first and second frames;

computer program code for estimating a patch motion vector for each of a plurality of patches of motion vectors based on one of motion vectors in each patch and motion vectors in proximate patches; and

computer program code for allocating to each pixel in the frame, the patch motion vector of its corresponding patch.

In accordance with another aspect, there is provided a computer readable medium including a computer program for estimation motion based on perceived blur due to motion between a first frame and a second frame of a digital video sequence comprising, the computer program comprising:

computer program code for estimating a motion vector between the frames for each of a plurality of pixel blocks in the motion blurred frame;

computer program code for a patch motion vector for each of a plurality of patches of motion vectors based on one of motion vectors in each patch and motion vectors in proximate patches;

computer program code for allocating to each pixel in the first frame, the patch motion vector of its corresponding patch;

computer program code for weighting each pixel; and

computer program code for combining each patch motion vector and its respective pixel.

The methods and systems described herein provide the benefits of increased sharpness in digital video displayed on a hold-type display, such as for example an LCD device, without suffering excessive noise amplification as is common in many known inverse filtering methods and without requiring modification of the hold-type display hardware itself. Furthermore, by grouping pixels and patching motion vectors, prominent global and local object motion in the frame for the perceived motion blur can be determined quickly.

1. A method of motion estimation based on perceived blur due to motion between a first frame and a second frame of a digital video sequence using estimates of motion direction and motion extent of pixels between the frames, the method comprising:
generating an initial guess frame based on the first frame;
blurring pixels in the guess frame as a function of their respective estimated blur directions and blur extents;
comparing each blurred pixel with a respective pixel in the first frame to generate a motion variable pixel for each respective pixel;
weighting each motion variable pixel; and
combining each motion variable pixel and its respective pixel in the initial guess frame.

2. The method of claim 1, wherein the weighting is a function of the respective pixel motion.

3. The method of claim 2, wherein the weighting is an estimate of the edge magnitude of the respective pixel in the guess image in the direction of pixel motion.

4. The method of claim 2 wherein the pixel blurring, comparing, motion variable pixel blurring and weighting, and combining are performed iteratively.

5. The method of claim 4 wherein the pixel blurring, comparing, motion variable pixel blurring and weighting, and combining are performed iteratively until a sum of error falls below a threshold level.

6. The method of claim 4 wherein the pixel blurring, comparing, motion variable pixel blurring and weighting, and combining are performed iteratively a predetermined number of times.

7. The method of claim 4 wherein the pixel blurring, comparing, motion variable pixel blurring and weighting, and combining are performed iteratively until a sum of error fails to change by more than a threshold amount between successive iterations.

8. A computer readable medium embodying a program of instructions executable by the computer to perform the method of claim 1.

9. A method of motion estimation based on perceived blur due to motion between a first frame and a second frame of a digital video sequence comprising:
estimating a motion vector between the frames for each of a plurality of pixel blocks in the frames;
estimating a cluster motion vector for each of a plurality of clusters of motion vectors based on one of motion vectors in each cluster and motion vectors in proximate clusters;
allocating to each pixel in the first frame, the cluster motion vector of its corresponding cluster;
generating an initial guess frame based on the first frame;
blurring pixels in the guess frame as a function of their respective allocated cluster motion vector;
comparing each blurred pixel with a respective pixel in the first frame to generate a motion variable pixel for each respective pixel;
weighting each motion variable pixel; and
combining each motion variable pixel and its respective pixel in the initial guess frame.
A system for compensating for perceived blur due to motion between a first frame and a second frame of a digital video sequence using estimates of motion direction and motion extent of pixels between the frames, the system comprising:
a motion blur filter array blurring pixels in an initial guess image, that is based on the first frame, as a function of their respective estimated blur directions and blur extents;
a comparator comparing each blurred pixel with a respective pixel in the first frame to generate a motion variable pixel for each respective pixel, said motion blur filter array further weighting each motion variable pixel; and
an algorithm combining each motion variable pixel and its respective pixel in the initial guess frame.

10. The system of claim 9, wherein the weighting is a function of the respective pixel motion.

11. The system of claim 9, wherein the weighting is an estimate of the edge magnitude of the respective pixel in the guess image in the direction of pixel motion.

12. The system of claim 9 wherein the initial guess frame is the first frame.

13. The system of claim 9 wherein the initial guess frame is the first frame.

14. The system of claim 9, wherein the motion blur filter array provides weighting based on an estimate of the edge magnitude of the respective pixel in the guess frame in the direction of pixel motion.

15. The system of claim 9 wherein the motion blur filter array, the comparator and the algorithm iteratively perform the blurring, comparing, blurring and weighting, and combining.

16. The system of claim 9 wherein the motion blur filter array, the comparator and the algorithm iteratively perform the blurring, comparing, blurring and weighting, and combining until the sum of error falls below a threshold level.

17. The system of claim 9 wherein the motion blur filter array, the comparator and the algorithm iteratively perform the blurring, comparing, blurring and weighting, and combining a predetermined number of times.

18. The system of claim 9 wherein motion blur filter array, the comparator and the algorithm iteratively perform the blurring, comparing, blurring and weighting, and combining until the sum of error fails to change by more than a threshold amount between successive iterations.
